(19) United States
(12) Patent Application Publication
(10) Pub. No.: US 2012/0005927 A1
(43) Pub. Date: Jan. 12, 2012

(54) Advertising sculpture, (alternate possible titles: Message tower, new media sculpture, advertising-imaging sculpture, advertising-imaging structure, marketing tower, marketing sculpture)

(76) Inventor: Kevin Stan Wallace, Lake Grove, NY (US)

(21) Appl. No.: 12/806,611

(22) Filed: Aug. 17, 2010

Related U.S. Application Data
(60) Provisional application No. 61/272,112, filed on Aug. 18, 2009.

(51) Int. Cl. G09F 19/00

(52) U.S. Cl. 40/1

(57) ABSTRACT

A new apparatus called a Message Tower (formerly titled an “Advertising Sculpture”) is disclosed. It is a towering 3-dimensional marketing utility, created specifically for the purpose of displaying illuminated advertising, imagery, and other new media, on a monumental scale, in 3 dimensions, preferably in association with related trade show events. A Message Tower is a new classification of structure all its own; it is not a building, nor a monument, nor a broadcast tower, nor on industrial structure.

### CROSS-REFERENCE TO RELATED APPLICATIONS

Not Applicable

### STATEMENT REGARDING FEDERALLY SPONSORED RESEARCH

Not Applicable

### REFERENCE TO SEQUENCE LISTING, TABLE, OR COMPUTER PROGRAM

Not Applicable

### BACKGROUND AND DESCRIPTION OF THE INVENTION

Any of the titles cited above (“Advertising Sculpture,” “Message Tower,” etc.), should be considered synonymous when seen in this Specification.

Advertising Sculptures are revolutionary 3-dimensional sculptural advertising utilities designed specifically for the purpose of displaying illuminated advertisements, imagery, and other new media upon its entire 3-dimensional surface (or upon a substantial portion of its 3-dimensional surface).

Advertising Sculptures may be built in a variety of sizes, though they are intended to tower over the heights of surrounding buildings, as to stand out and be seen from a distance.

Advertising Sculptures are an altogether novel and unprecedented category of structural utility all their own. They cannot be classified as a building, nor can they be classified as a monument, nor can they be classified as a broadcast tower, nor can they be classified as an electrical tower, nor as a signpost, nor as a bridge pylon, all of which may be defined as known classifications of structural apparatuses, each that serve a distinct purpose.

Advertising Sculptures are not buildings. Although these Advertising Sculptures are larger than many buildings, the foremost purpose of these structures is to display advertisements and imagery, not to serve as habitable buildings. Advertising Sculptures are not buildings. A distinct and fundamental difference is that the purpose and function of a building is to supply habitable space, which is not a concern of these Advertising-Imaging Sculptures.

(Advertising Sculptures may however be fitted with some habitable space, but that is not the reason or purpose for their creation.)

Advertising Sculptures are not monuments. The purpose of a monument is to stand as static and fixed symbol, emblem or marker, such as the Statute of Liberty, the Washington Monument, or Mount Rushmore, for example. Monuments by their nature are not used for advertising or imagery. Advertising Sculptures, in contrast, again, are created for the purpose of displaying illuminated advertising, imagery, and other new media upon its entire 3-dimensional surface (or a substantial portion of its 3-dimensional surface.)

(Advertising Sculptures may appear monumental in size, but they are fundamentally not monuments because they defy the static, fixed and emblematic nature of a monument. Since the visual content of an Advertising Sculpture's surface is malleable, it is capable representing an infinite number of free-flowing symbols, emblems, or markers, and therefore cannot be characterized as a monument, as the fundamental nature of a monument is, again, a static and fixed symbol, imbued with a pre-determined and fixed meaning.)

Advertising Sculptures are not broadcast towers. The purpose of a broadcast tower is to relay radio signals from a large antenna structure at a high elevation. Although Advertising Sculptures may hold, or be fitted with, broadcast antennas, again, their primary purpose is to display illuminated advertising and imagery, not to broadcast radio signals.

Advertising-Imaging Sculptures are not signposts, bridge pylons, or electrical towers either, for reasons that are obvious.

So the invention of the Advertising Sculpture utility represents an altogether new and unprecedented category of structure that does not exist.

### Originality of the Invention:

The novelty and unprecedented nature of this invention of Advertising Sculptures is that they are 3-dimensional. They serve a revolutionary purpose of offering a fully 3-dimensional means of displaying advertising and imagery, as opposed to the limited functionality of a 2-dimensional billboard, module, sheet, or screen. Whereas 2-dimensional billboards, modules, sheets, or screens have been employed for the purposes of advertising for hundreds (perhaps even thousands) of years, there has never been a 3-dimensional illuminated Advertising-Imaging Sculpture in recorded history.

### Distinction of the Invention:

The very essence and perception of a 3-dimensional object is fundamentally and inherently different and distinct from the essence and psychological perception of a 2-dimensional object.

A painting, a drawing, or a photograph, for example, is a 2-dimensional work of art. A sculpture is a 3-dimensional work of art. Any layperson, patent examiner, or “ordinary observer,” with or without an education in any of the visual arts, fine arts, or communications, would clearly and unquestionably perceive the obvious difference between the essence of a 3-dimensional sculpture, and its fundamental and inherent difference and distinction from, the essence of a 2-dimensional picture.

Just as a television set or a computer monitor consist of a 2-dimensional screen, there is no such invention of a television set or a computer monitor designed to be displayed or viewed in 3-dimensions.

### Non-Obvious Nature of the Invention:

Advertising Sculptures are not an obvious invention because they do not exist in society, nor has anything similar to them ever appeared in science fiction literature or film.

Advertising Sculptures are not an improvement on a pre-existing invention either.

For example, Advertising Sculptures are not an extension of a billboard, because a billboard is a self-contained 2-dimensional device, which has no claim outside of its intended, manufactured, and practiced use.

Advertising Sculptures are not an extension of a sign either, nor are they an extension of a module, nor are they an extension of a sheet, nor are they an extension of a screen, nor are they an extension of any other self-contained component.

Furthermore, the common and instantaneous perception of a 2-dimensional sign, whether mounted on a building or a pole, is just that—a sign mounted on a building or a pole.

The instantaneous psychological perception of an Advertising Sculpture however, perceives the invention as a whole sculpture—an entire and complete 3-dimensional illuminated object.

An Advertising Sculpture is not looked at or thought of as an individual 2-dimensional module, nor is it looked, at or thought of as an individual 2-dimensional board, nor is it thought of as a 2-dimensional sheet, nor as a 2-dimensional sign, nor as a 2-dimensional component.

Nor is an Advertising Sculpture looked at as a grouping of independent modules, or boards, or sheets, or signs, or components, but rather, again, it is instantly perceived as a whole and complete 3-dimensional sculpture.

Perhaps the very best evidence that Advertising Sculptures are in fact a non-obvious invention is this:

There are literally HUNDREDS of 2-dimensional illuminated billboards, modules, sheets, and screens mounted to buildings in Times Square in New York City. Moreover, there are literally MILLIONS of people a day who pass through Times Square and stare up at those illuminated billboards for HOURS. This has occurred for well over the past 10 to 20 YEARS.

If this invention of Advertising Sculptures were obvious, then why wouldn't the millions of people staring up at all of those hundreds of billboards on all of those buildings in Times Square for the past 10 to 20 years ever think of it?

It is not an obvious invention—period.

To wit, a recent and highly relevant case law analogy lends significant credence to the distinction between the psychological impression of a whole 3-dimensional object, versus any myriad of its individual or interchangeable components:

The current copyright law in the United States with regard to copyright protection of an individual architectural building holds that, the individuality, and protection of the individuality, of a specific building design is based on the overall 3-dimensional “total look and feel” of the building, and the impression that the building as a whole creates in the mind of a viewer. (This was affirmed, upheld, and ruled upon in the recent 2005 judgment in the case of Shine v. Childs in Manhattan, N.Y.)

The significance of mentioning this ruling and analogy is that it distinguishes and confirms the importance of the overall impression of a 3-dimensional object, versus the lesser significant and largely irrelevant issue of a myriad of interchangeable parts or components (such as windows, columns, staircases, arches, trusses, bricks, light bulbs, etc). Although this analogy is from the realm of copyright law, the fact that the courts recognized such a distinction as a way of validating and characterizing intellectual property, is very significant in itself.

Therefore, it is highly sound and reasonable to assert that the overall psychological impression of these striking 3-dimensional Advertising Sculptures distinguishes and sets them apart as a novel and unprecedented invention, distinctly different from any 2-dimensional modules, boards, signs, sheets, screens or other components, and, to restate, distinctly different from any other known classification of structure.

### BRIEF TECHNICAL DESCRIPTION OF THE INVENTION

The surface of these Advertising-Imaging Sculptures would be comprised of any, or any combination of, the following types of visual light-generating materials: Light Emitting Diodes (LEDs), Liquid Crystal Displays (LCDs), Surface-conduction Electron-emitter panels (SEDs), Organic Light-Emitting Diodes (OLEDs), Field Emission Display panels (FED)s, or high-definition plasma panels; however, the surface of these Advertising Sculptures are by no means limited to these kinds of technologies.

It is also important to point out that the engineering aspects of these Advertising Sculptures could be undertaken by any person(s) of qualified skill in the fields of electrical engineering and structural engineering.

Furthermore, the specific technology and materials used to illuminate these Advertising Sculptures is far less relevant in contrast to the overall defining essence of the invention; namely, a towering 3-dimensional sculptural utility capable of displaying illuminated advertising and imagery upon its 3-dimensional surface above the surrounding buildings of a city.

### Eco-Versions of the Invention

Advertising Sculptures could also be built to be entirely, or to a great degree, eco-powered. They would achieve this by integrating solar panels and/or an array of micro wind turbines into portions of their façade.

### BRIEF DESCRIPTION OF THE VIEWS OF THE INVENTION

Note: The main example of an Advertising Sculpture featured in these images is only one style of this new utility. 174 styles of Advertising-Imaging Sculptures have been designed by the inventor and will be submitted to this Patent Application during the Non-Provisional Patent filing stage, and/or filed as separate Design Patents, within one year.

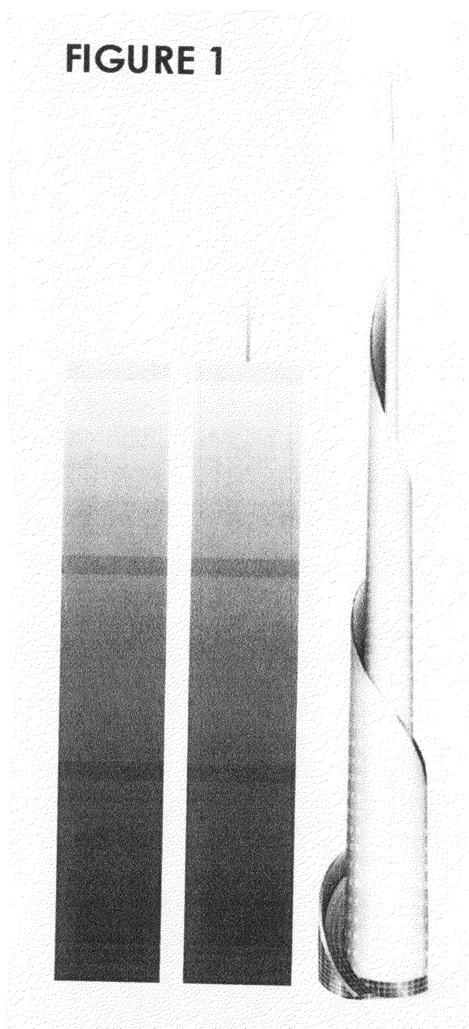

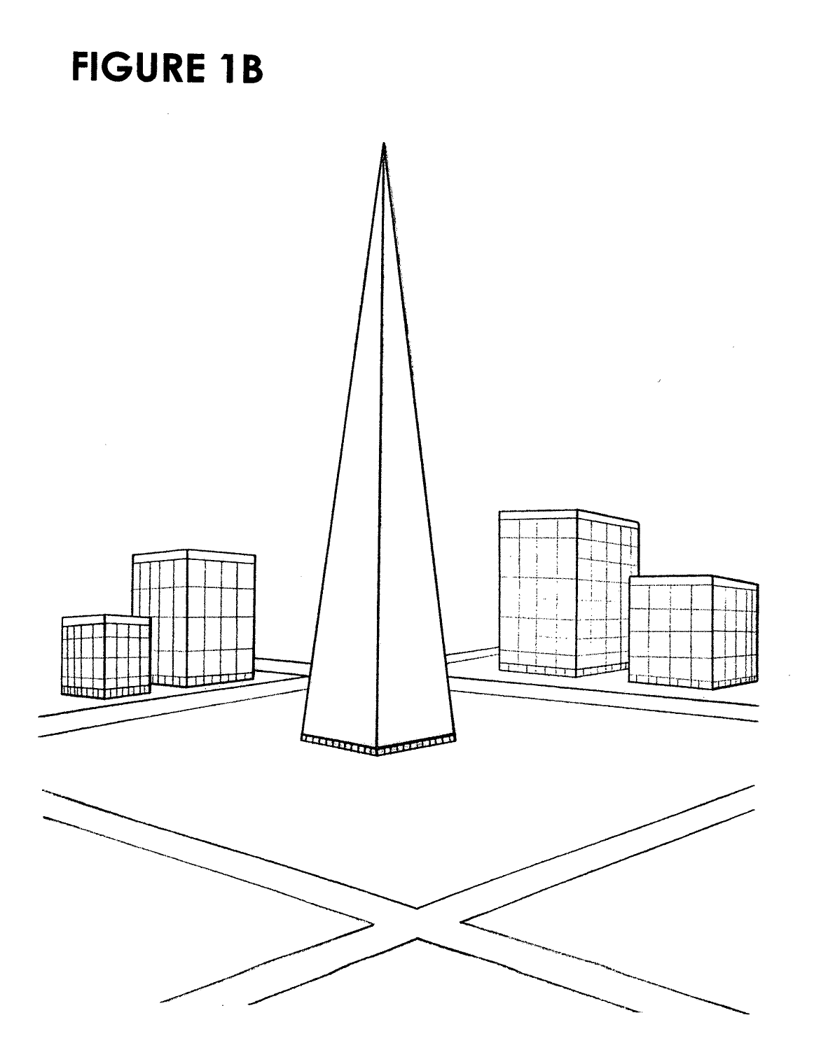

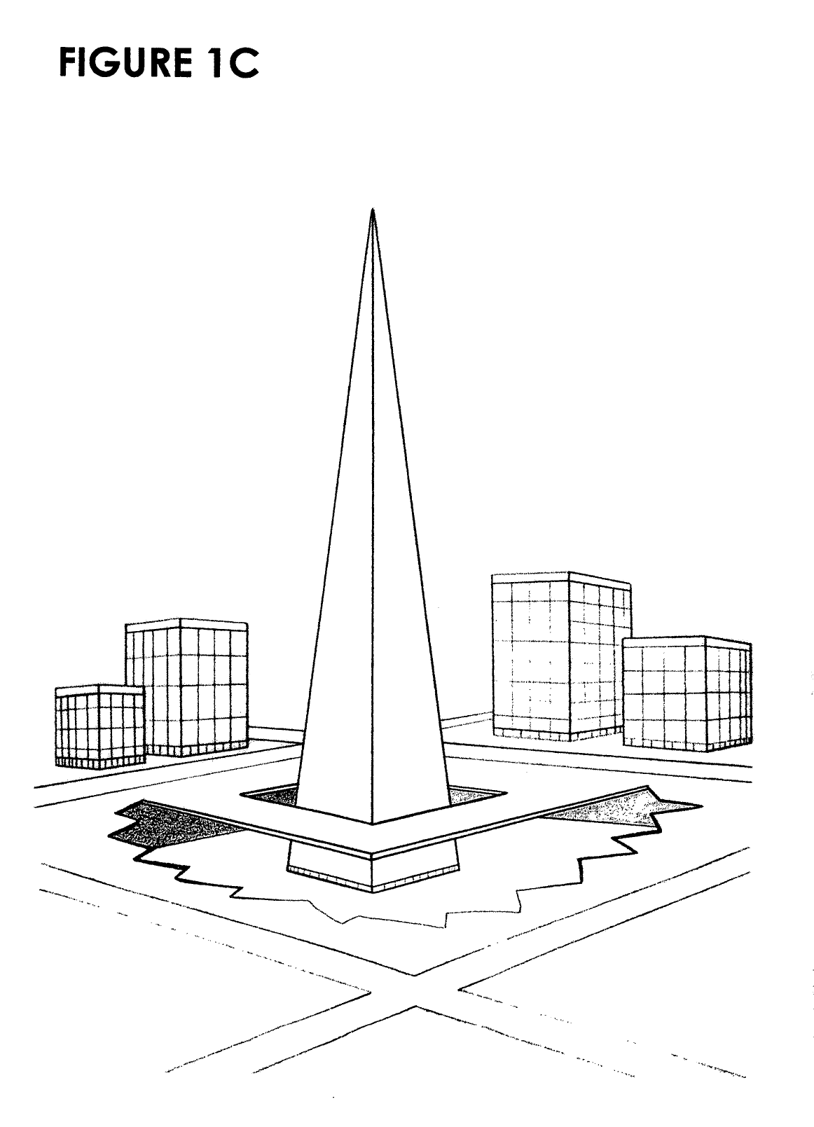

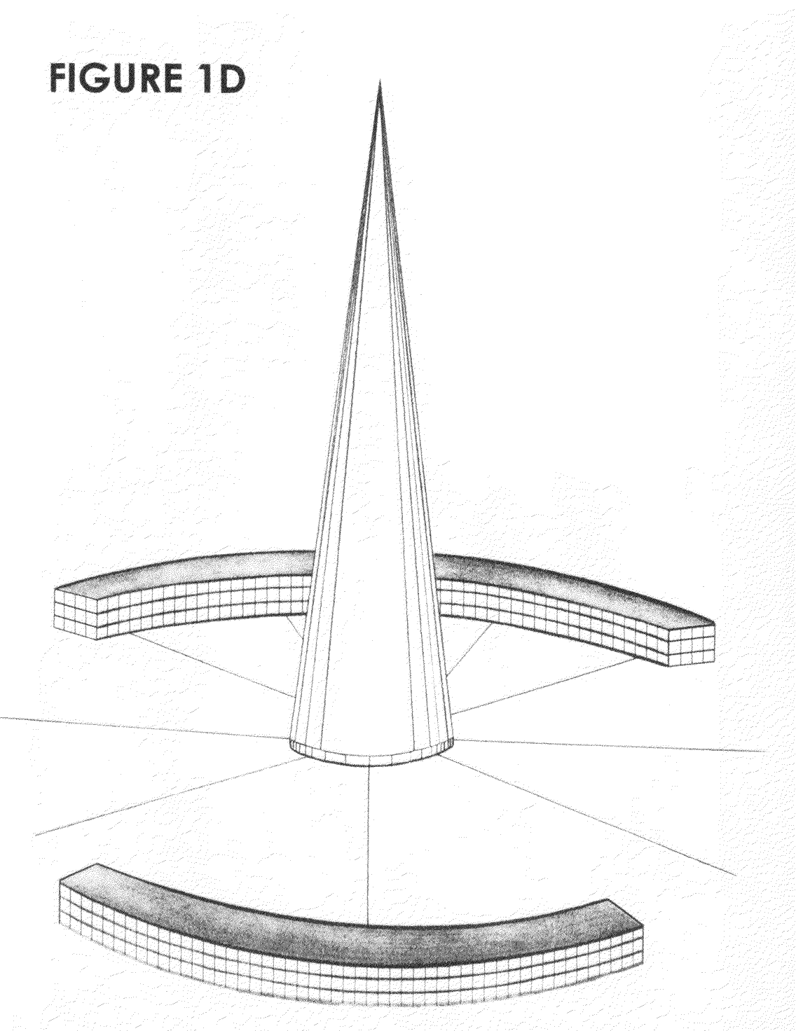

FIG. 1: Advertising Sculpture—Section

This figure shows a large Advertising Sculpture as compared to the size of the former World Trade Center twin towers (most people are familiar with their size). You will notice the 3-dimensional spiral shape of the Advertising Sculpture. Illuminated advertising, imagery and new media would be displayed upon virtually the entire 3-dimensional surface of the Advertising Sculpture.

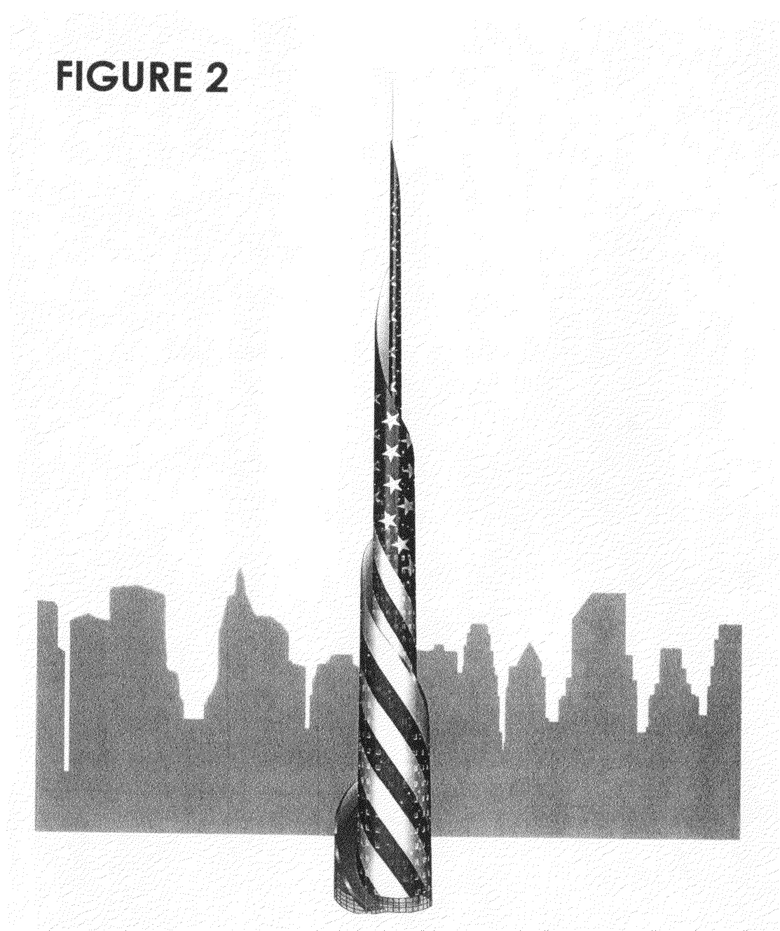

FIG. 2: Advertising Sculpture—Section 2

This figure shows an Advertising Sculpture displaying an illuminated image of an American Flag upon virtually its entire surface.

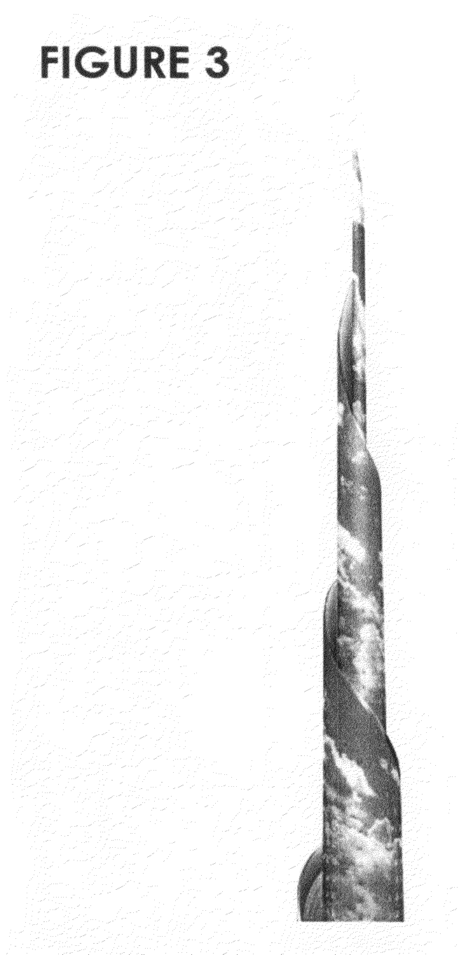

FIG. 3: Advertising Sculpture—Section 3

This figure shows an Advertising Sculpture displaying illuminated imagery of clouds in the sky upon virtually its entire surface.

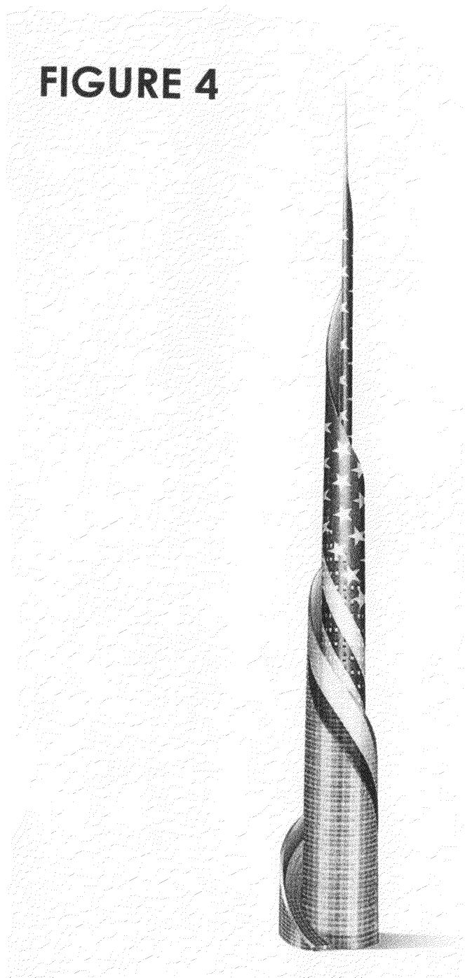

FIG. 4: Advertising Sculpture—Section 4

This figure shows an Advertising Sculpture that has been fitted to permit a few habitable floors in the bottom portion of the sculpture. You will notice that the illuminated image of an American Flag still occupies the majority of the surface of the sculpture.

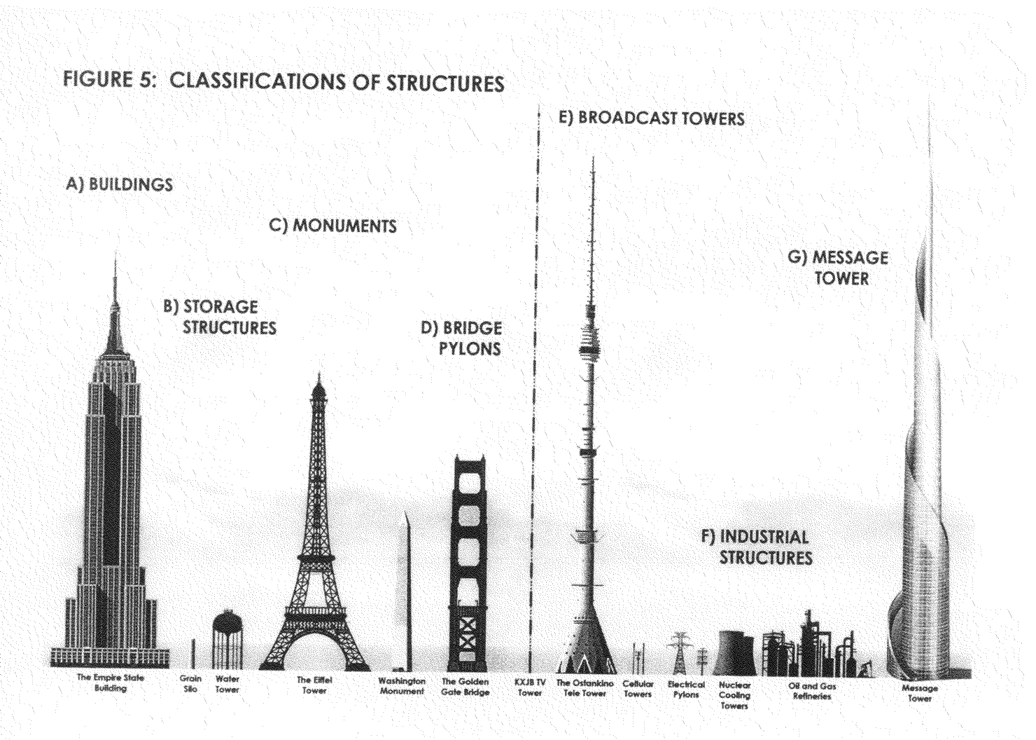

FIG. 5: Categories of Structures—Section 5

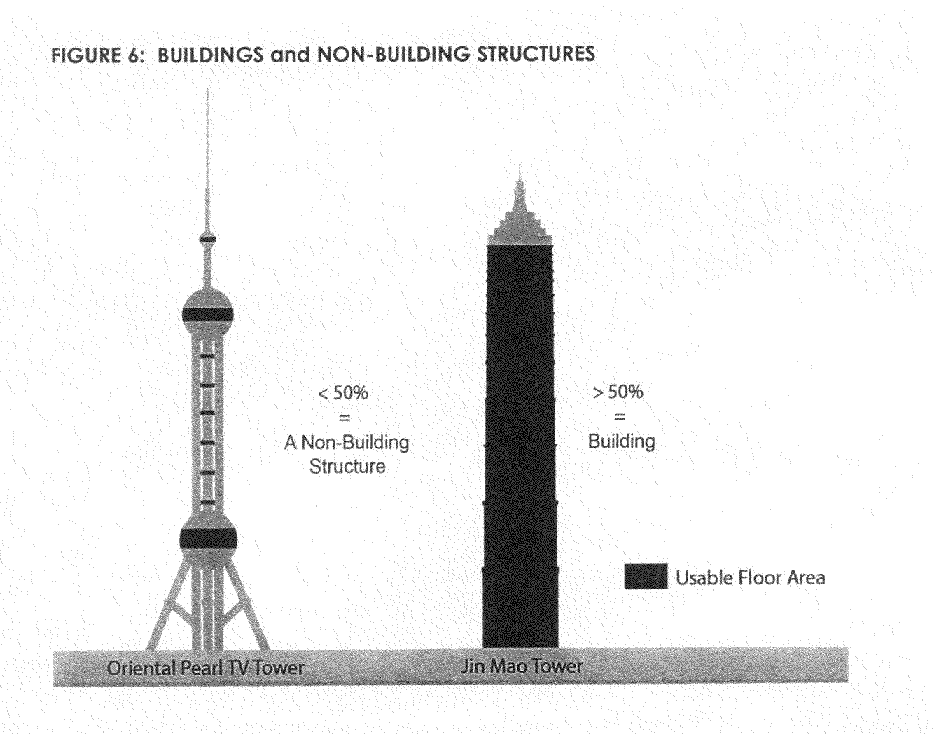

This figure shows examples of 3 (out of 5) known categories of structures, to contrast with the invention of the Advertising Sculpture, which is featured in proportion in the following FIG. 6:

FIG. 6: Categories of Structures—Section 6

This figure shows the additional 2 examples of categories of known structures (out of 5). contrasted alongside the invention of the Advertising Sculpture.

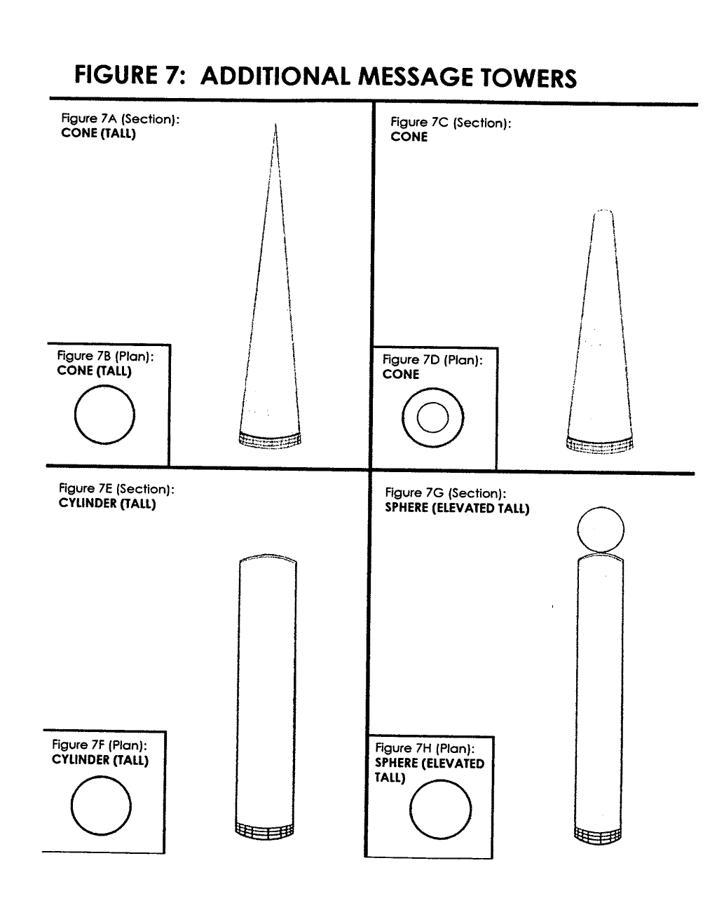

FIG. 7: Additional Advertising Sculptures—Sections and Plans 7A-7H

This figure shows 4 additional examples of styles of Advertising Sculptures. They are: Cone (Tall), Cone, Cylinder (Tall), and Sphere (Elevated Tall).

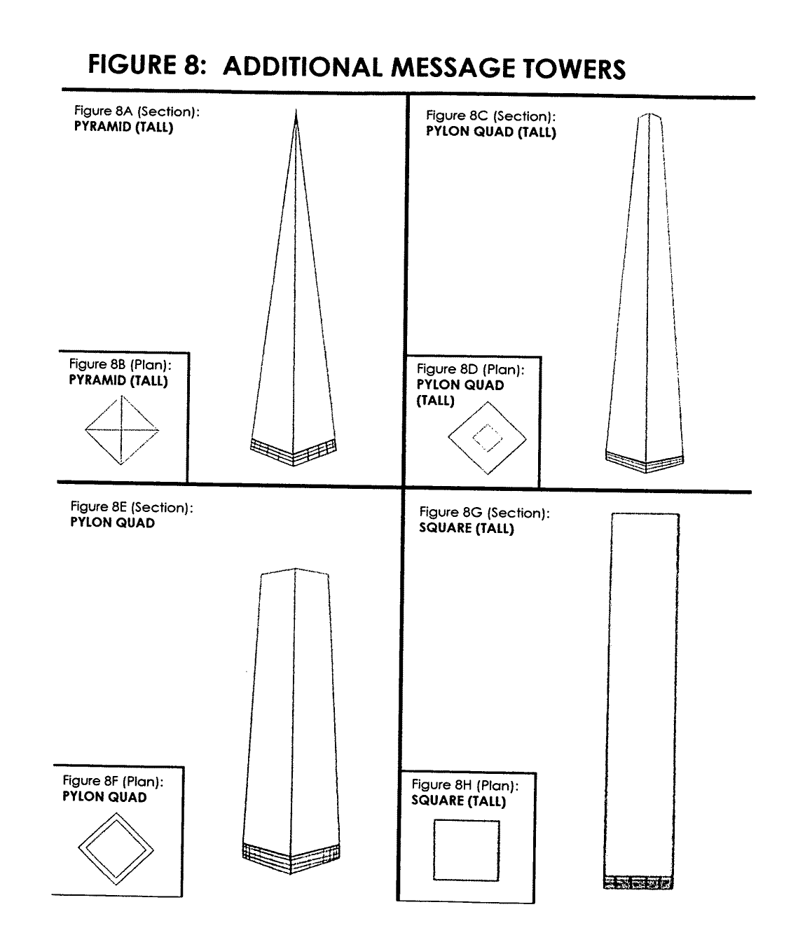

FIG. 8: Additional Advertising Sculptures—Sections and Plans 8A-8H

This figure shows 4 more examples of styles of Advertising Sculptures. They are: Pyramid (Tall), Pylon Quad (Tall), Pylon Quad, and Square (Tall).

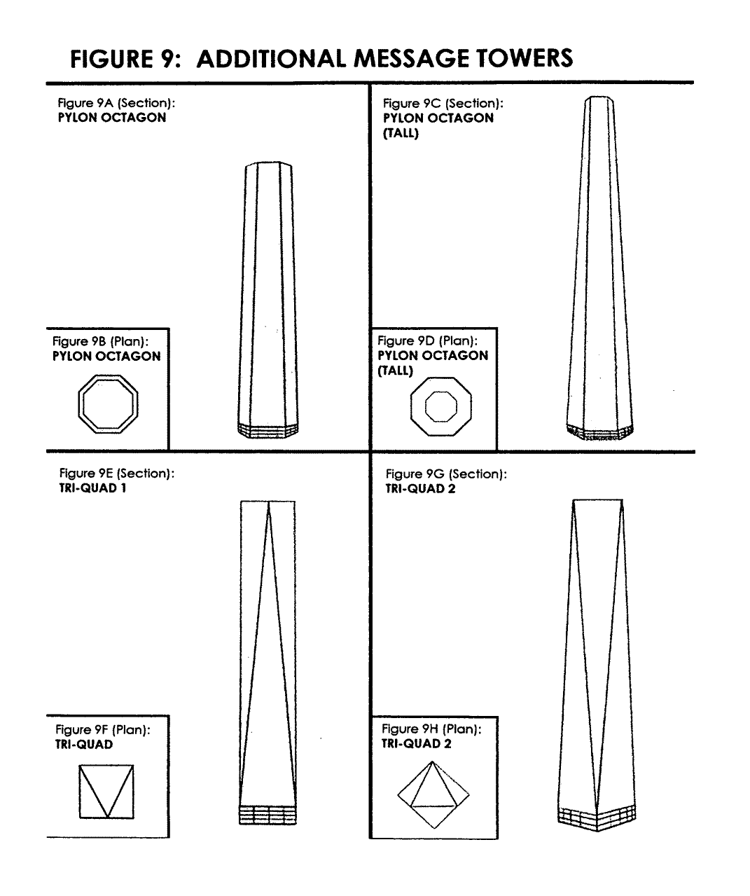

FIG. 9: Additional Advertising Sculptures—Sections and Plans 9A-9H

This figure shows 4 more styles of Advertising Sculptures. They are: Pylon Octagon, Pylon Octagon (Tall), Tri-Quad 1, and Tri-Quad 2.

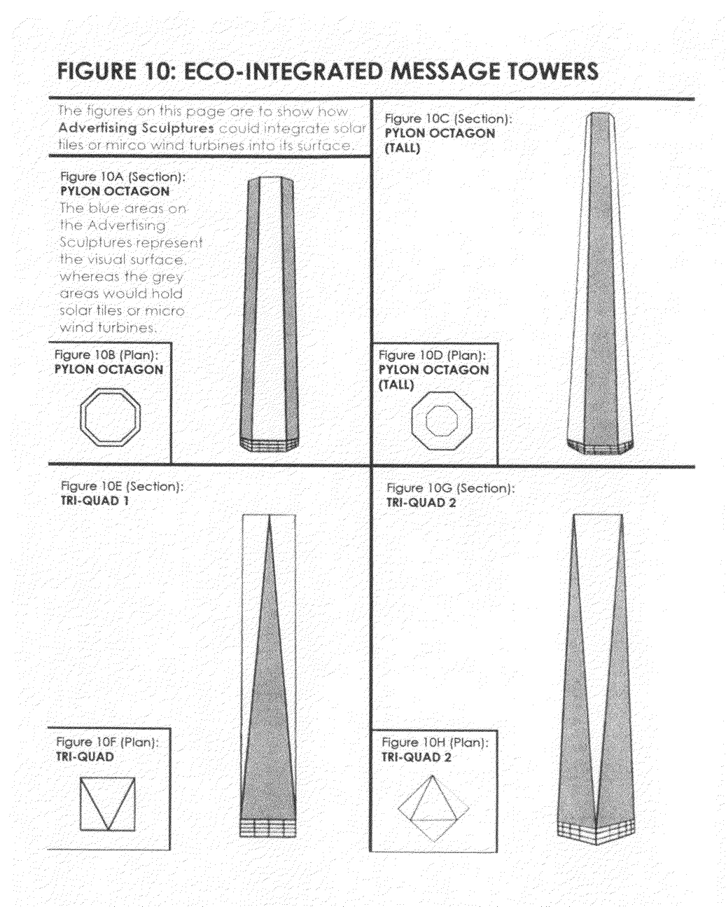

FIG. 10: Eco-Integrated Advertising Sculptures—Sections and Plans 10A-10H

This figure shows the previous 4 styles integrated with proposed solar panels and/or micro wind turbines, which could provide ample eco-power to operate the Advertising Sculptures.

### DIFFERENT STYLES OF THE INVENTION

There are currently 174 styles of Advertising-Illuminated Sculptures that have been designed by the inventor, some of which are shown in this Provisional Patent Application. The remaining styles will either be submitted with the Non-Provisional Patent Application filing, and/or with a separate filing of Design Patent Applications, within one year. Here is the list of styles:
1) Cone—featured in this Provisional Patent Application
2) Cone (Tall)—featured in this Provisional Patent Application
3) Cone (Short)
4) Pylon (Triangular)
5) Pylon (Triangular Tall)
6) Pylon (Triangular Short)
7) Pylon (Quad)—featured in this Provisional Patent Application
8) Pylon (Quad Tall)—featured in this Provisional Patent Application
9) Pylon (Quad Short)
10) Pylon (Pentagon)
11) Pylon (Pentagon Tall)
12) Pylon (Pentagon Short)
12B) Pylon (Hexagon)
14) Pylon (Hexagon Tall)
15) Pylon (Hexagon Short)
16) Pylon (Heptagon)
17) Pylon (Heptagon Tall)
18) Pylon (Heptagon Short)
19) Pylon (Octagon)—featured in this Provisional Patent Application
20) Pylon (Octagon Tall)—featured in this Provisional Patent Application
21) Pylon (Octagon Short)
22) Pylon (Nonagon)
23) Pylon (Nonagon Tall)
24) Pylon (Nonagon Short)
25) Pylon (Tetragon)
26) Pylon (Tetragon Tall)
27) Pylon (Tetragon Short)
28) Pylon (Hendecagon)
29) Pylon (Hendecagon Tall)
30) Pylon (Hendecagon Short)
31) Pylon (Dodecagon)
32) Pylon (Dodecagon Tall)
33) Pylon (Dodecagon Short)
34) Pylon (Tetradeca)
35) Pylon (Tetradeca Tall)
36) Pylon (Tetradeca Short)
37) Spiral
38) Spiral (Tall)—Main Style featured in this Provisional Patent Application
39) Spiral (Short)
40) Cylinder
41) Cylinder (Tall)—featured in this Provisional Patent Application
42) Cylinder (Short)
43) Square
44) Square (Tall)—Featured in this Provisional Patent Application
45) Square (Short)
46) Rectangle
47) Rectangle (Tall)
48) Rectangle (Short)
49) Rhombus
50) Rhombus (Tall)
51) Rhombus (Short)
52) Sphere
53) Sphere (Elevated Tall)—Featured in this Provisional Patent Application
54) Sphere (Elevated Short)
55) Stepped Sculpture
56) Stepped (Tall)
57) Stepped (Short)
58) Feminine Sculpture
59) Feminine (Tall)
60) Feminine (Short)
61) Masculine Sculpture
62) Masculine (Tall)
63) Masculine (Short)
64) Column
65) Column (Tall)
66) Column (Short)
67) Egg
68) Egg (Tall)
69) Egg (Short)
70) Dome
71) Dome (Tall)
72) Dome (Short)
73) Drop
74) Drop (Tall)
75) Drop (Short).
76) Bi-Petal
77) Bi-Petal (Tall)
78) Bi-Petal (Short)
79) Tri-Petal
80) Tri Petal (Tall)
81) Tri-Petal (Short)
82) Quad Petal
83) Quad Petal (Tall)
84) Quad Petal (Short)
85) Penta-Petal
86) Penta-Petal (Tall)
87) Penta-Petal (Short)
88) Hexa-Petal
89) Hexa-Petal (Tall)
90) Hexa-Petal (Short)
91) Bi-Star
92) Bi-Star (Tall)
93) Bi-Star (Short)
94) Tri-Star
95) Tri-Star (Tall)
96) Tri-Star (Short)
97) Quad Star
98) Quad Star (Tall)
99) Quad Star (Short)
100) Penta-Star
101) Penta-Star (Tall)
102) Penta-Star (Short)
103) Hexa-Star
104) Hexa-Star (Tall)
105) Hexa-Star (Short)
106) Cross
107) Cross (Tall)
108) Cross (Short)
109) Bi-Plain Angle
110) Bi-Plain Angle (Tall)
111) Bi-Plain Angle (Short)
112) Tri-Plain Angle
113) Tri-Plain Angle (Tall)
114) Tri-Plain Angle (Short)
115) Quad-Plain Angle
116) Quad-Plain Angle (Tall)
117) Quad-Plain Angle (Short)
118) Penta-Plain Angle
119) Penta-Plain Angle (Tall)
120) Penta-Plain Angle (Short)
121) Hexa-Plain Angle
122) Hexa-Plain Angle (Tall)
123) Hexa-Plain Angle (Short)
124) Eye
125) Eye (Tall)
126) Eye (Short)
127) Concave Plain
128) Concave Plain (Tall)
129) Concave Plain (Short)
130) Bi-Concave Plain
131) Bi-Concave Plain (Tall)
132) Bi-Concave Plain (Short)
133) Tri-Concave Plain
134) Tri-Concave Plain (Tall)
135) Tri-Concave Plain (Short)
136) Quad-Concave
137) Quad-Concave (Tall)
138) Quad-Concave (Short)
139) Penta Concave
140) Penta Concave (Tall)
141) Penta Concave (Short)
142) Hexa Concave
143) Hexa Concave (Tall)
144) Hexa Concave (Short)
145) Pyramid
146) Pyramid (Tall)—featured in this Provisional Patent Application
147) Pyramid (Short)
148) Tri-Quad 1—featured in this Provisional Patent Application
149) Tri-Quad 1 (Tall)
150) Tri-Quad 1 (Short)
151) Tri-Quad 2—featured in this Provisional Patent Application
152) Tri-Quad 2 (Tall)
153) Tri-Quad 2 (Short)
154) Tri-Penta 1
155) Tri-Penta 2 (Tall)
156) Tri-Penta 2 (Short)
157) Tri-Penta 2
158) Tri-Penta 2 (Tall)
159) Tri-Penta 2 (Short)
160) Tri-Hexa 1
161) Tri-Hexa 1 (Tall)
162) Tri-Hexa 1 (Short)
163) Tri-Hexa 2
164) Tri-Hexa 2 (Tall)
165) Tri-Hexa 2 (Short)
166) Quad-Hexa
167) Quad-Hexa (Tall)
168) Quad-Hexa (Short)
169) Hexa-Quad
170) Hexa-Quad (Tall)
171) Hexa-Quad (Short)
172) Octa-Quad
173) Octa-Quad (Tall)
174) Octa-Quad (Short)

### RECAP SUMMARY

This Specification and the 10 Figures included herein represent a concrete and tangible expression of an original idea:

The idea being to create a towering 3-dimensional sculptural utility, capable of displaying illuminated advertising, imagery, and other new media upon its 3-dimensional surface above the surrounding buildings of a city.

The concrete and tangible expression of this idea is the novel invention herein expressed as an Advertising Sculpture (or an “Advertising-Imaging Sculpture,” or an “Advertising-Imaging Structure”).

1. An “Advertising Sculpture” is a 3-dimensional advertising, marketing, imaging, and new-media utility that can display advertisements, images, and Internet content upon its entire (or a substantial portion of its entire) 3-dimensional surface.
